(19) United States
(12) Patent Application Publication
(10) Pub. No.: US 2020/0315239 A1
(43) Pub. Date: Oct. 8, 2020

(54) EDIBLE PRODUCT OF ANIMAL ORIGIN AND PRODUCTION METHOD

(71) Applicant: Grupo Bimbo, S. A. B. de C. V., Mexico City (MX)

(72) Inventor: Espiridion Valdes Rodriguez, Toluca (MX)

(73) Assignee: Grupo Bimbo, S. A. B. de C. V.

(21) Appl. No.: 16/909,703

(22) Filed: Jun. 23, 2020

Related U.S. Application Data
(62) Division of application No. 14/787,237, filed on Oct. 26, 2015.

(51) Int. Cl. A23P 30/10; A23K 50/40; A23K 40/20; A23K 10/26; A23L 13/20; A23L 33/20

(52) U.S. Cl. CPC A23P 30/10; A23K 50/40; A23L 33/20; A23K 10/26; A23L 13/20; A23K 40/20

(57) ABSTRACT

The invention relates to an edible product of animal origin and method for preparing same. The edible product comprises moulded pork rinds prepared by crumbling unfried pig skin to form crumbled pig skin, placing the crumbled pig skin into previously heated moulds, and subjecting the crumbled pig skin in the previously heated moulds to pressure for a certain period of time.

### RELATED APPLICATIONS

The application is a divisional application of U.S. patent application Ser. No. 14/787,237, filed Oct. 26, 2015, which claims the benefit under 35 U.S.C. § 371 of International Application No. PCT/MX2013/000053, filed Apr. 26, 2013, which applications are hereby incorporated by reference in their entireties.

### DESCRIPTION

The invention of the present application falls under the scope of the food industry, as said invention provides a novelty edible product and a particular method for producing said product, so that both product and method of the invention provide teachings which until today have not been practiced, particularly if the nature and specificity of the product are considered, as the operation conditions and stages or steps involved in product development are dictated by origin or nature of the raw materials used as well as by the characteristics of the final product obtained.

Specifically, the edible product of the invention is known as a “chicharron or pork rind”, but substantially differs from pork rinds available in the market until today due to its characteristics such as presentation, physical properties and nutritional value, said characteristics deriving particularly from its preparation process.

It is known that, especially for those skilled persons in meat industrialization process, particularly in pork meat industrialization, whether it is an industrial level process or a “homemade” process as may be a process performed at a “meat store” or at restaurant facilities, the traditional preparation of pork rinds basically consists of frying the “pig skin” in a trough containing a substantial fat volume at a temperature slightly above the point of boiling, for a certain period of time and at the discretion of the butcher or employee in charge of the “frying pan”, until a fried point in which the product is well fried, basically based on the pork rinds color, because said color is a very important factor for stimulating the appetite and for catching the interest of the customer or diner of the product concerned.

An additional step of the chicharron or pork rinds production method is draining the product off before it is consumed in order to remove the fat excess as much as possible, because it is a product which is expanded during the frying process and it is common that a fat excess occludes the pork rind body obtained.

It is important to mention that the traditional method for producing pork rinds does not always meet the principles of hygiene for handling food. It is enough to have a look at the frying pan or saucepan wherein the pig skin is fried to doubt about buying the product, and said situation could be worse due to the conditions of the environment and facilities where the pork rinds are produced.

Another issue derived from the homemade production, exhibition and sale of the food product concerned is that said product always or generally is exposed to contamination, which is specially caused by careless handling and from its directly exhibition to the environment. In addition to the abovementioned, another problem is the product quality, since the product is derived from pig and its frying process is performed using pork fat, the resulting product has a very high fat content and for that reason there are less and less consumers willing to eat it. Generally people tend to avoid eating food which increases health risk, because it is known to everyone that products produced with a fat excess involve serious health issues.

Until today significant efforts have been made in order to offer to the consumer an edible product of pork rinds that meets the hygiene measures needed for producing edible products in an industrial level, i.e. a product having enough quality and produced in an sufficient amount to satisfy the national market and even satisfy the exportation market, product that as the fritters or snacks could be sold in any supermarket or convenience store existing in any community, however small, which expands the possibilities of success for the product commercialization.

As consumers of meat products such as pork rinds may know, the flavor of this type of products may change over time due to the fact that they may become rancid as result of the oxidation of the fat contained. This determines the allowed time to be sold and consumed, forcing the trader to withdraw said products from the market, which involves economic losses. This situation has forced producers to search for solutions to avoid or minimize the existing problem, with the purpose of extending the shelf-life of this type of products, either by vacuum packaging or by adding preservatives; it is clear that regarding pork rinds industrialization this problem has been partially solved. Despite the efforts implemented in this field, the reality is that this industrialized pork rind product, which is now available in the market, is consumed despite the recommended health restrictions, because it is still consider a high fat product. Until today said characteristic keeps restricting its consumption, although it is an edible product very attractive as snack specially for Latin people.

Due to the importance of the pork rinds in the food diet of the population, wherein in several cases its consumption has been restricted as result of the real concern regarding the product effects over the health of the consumers, there are substantial efforts to develop a product with special characteristics of quality. And although said product is not a dietary food, it may be consumed even by those persons who consider it important to stay healthy and to maintain their weight within the recommended aesthetic aspect, especially now that the health sector recommends the diminution of body weight with the purpose of reducing government expenditures corresponding to the health sector.

### INVENTION OBJECTIVES

Therefore, it is a particular objective of the invention to provide a food product of general consumption, which due to its low fat content may be suitable for consumption even for those persons concerned about their health and weight.

Another objective of the current invention is the production of pork rinds having a longer shelf life than the shelf life of a similar food product available until today in the market.

It is still another objective of the invention to industrially produce a food product derived from pig skin, that regardless of its low fat content may have an attractive visual aspect and smell as well as the traditional taste of a pork rind.

A further objective of the present invention is an industrial method to produce pork rind, in which the step or stage of frying has been eliminated, obtaining a product with a crunchy texture and traditional pork rind taste.

It is still another objective of the invention to develop a method to industrialize the pork rind, from which a considerably percentage of fat has been removed, but even maintains its nutritional values as well as its consumption as snack.

It is still a further objective of the invention to develop a method which is intended to offer to the consumer market a shaped product having a particular shape which is used as support for a garnish having a thick consistency, e.g. garnishes as “pico de gallo”, guacamole, salsa or any other as it is traditional in Mexican cuisine.

It is still another objective of the invention to develop a method to industrialize the pig skin, that even when the raw material for producing said product is skin pork trifles, it provides a consistent product having a shape and physical characteristics making said product suitable for being used as support for a garnish, being said garnish one of the commonly used in the Mexican cuisine.

### BRIEF DESCRIPTION OF THE DRAWINGS

FIG. 1 of the accompanying drawings is a schematic view depicting the homemade process followed to produce pork rinds;

FIG. 2 is a schematic depiction of the different stages performed as part of the industrial method for producing pork rinds;

FIG. 3 is a schematic view depicting the different stages or steps of the industrial method of the current invention followed to produce pork rinds;

FIG. 4 is a view of the upper part of the product or pork rind obtained by implementing the method of the invention;

FIG. 5 is a front view of the product illustrated in FIG. 4 of the accompanying drawings; and

FIG. 6 is a front, cross-section view, according to the line a-a marked out in FIG. 4 of the drawings attached.

### DETAILED DESCRIPTION OF THE DRAWINGS AND THE PRESENTLY PREFERRED EMBODIMENTS

Below is a detailed description of the invention according to the accompanying drawings, said drawings are presented for the only purpose of illustrating more clearly the invention.

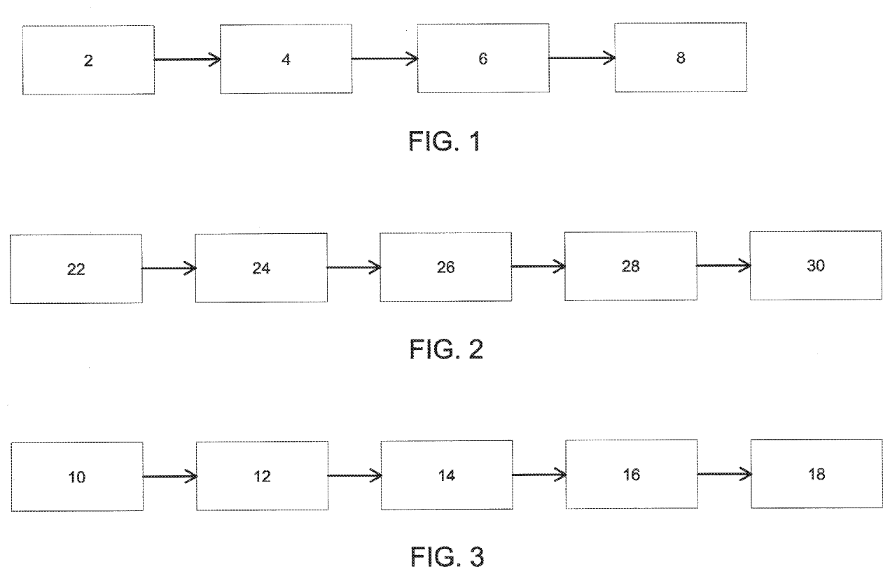

According to what is depicted in the accompanying drawings, particularly in FIGS. 1 and 2, which have illustrated in an schematic way the traditional methods followed to produce pork rinds, and FIG. 3 which has illustrated the method developed by the inventor of the current invention which protection is requested, and being obvious that said method meets all the legal provisions and regulations in compliance with the subject matter Law, my principal hereby requests grant of protection to his invention.

As illustrated in FIG. 1 of the accompanying drawings, the traditional method followed for the preparation of pork rind consists of frying the pig skin 2, said pig skin pieces being of substantial size, in a frying pan 4 containing pig fat at boiling point for the enough time, until the pig skin turns its color indicating it is enough fried. Once the pig skin is enough fried, said pig skin is removed from the frying pan and drained 6 in order to remove the fat excess from the pork rind awhile it is allowed to reach the environment temperature. With this step the product is finished 8, and it is available to clients who generally select the pieces of pork rinds that meet their culinary expectations. Of course the finished product can remain available to possible clients for varying periods. Here, the product is usually exposed to the environmental contamination, and for that reason said produced pork rinds are considered a non-hygienic product. Also the fat contained in the frying pan to fry said pig skin is not safe for being consumed.

Currently, significant efforts have been made to industrialize the concerning, said efforts comprising the improvement of sanitary conditions to produce said pork rind; however, the traditional steps are still followed with the exception of that before frying the pig skin, said pig skin is disposed in small pieces of a general square configuration of 2 cm by side and then is packaged for its display and sale. The product resulted from the pork rinds industrialization has other favorable characteristics, such as having a lower amount of monounsaturated fat, having reduced cholesterol content and having decreased energetic value. The producers consider said advantages very positive because they help to increase the product acceptance. Notwithstanding the foregoing, the pork rinds prepared under the guidelines abovementioned presents a substantial fat content, which could be easily corroborated by observing the pieces of said pork rind contained in the packages.

Both the pork rind produced using the traditional method and the pork rind produced using the industrialized method until now constitute an edible product, particularly a snack, or a product that could be used to prepare a stew, both ways of consumption being very tasty and both satisfying the taste preferences of the majority of the population, the exception being the population sector which is not able to consume said product due to a medical prescription, or for those who have an allergic reaction when eating said product, because definitely this is not a dietary product.

In the schematic depiction of the industrial method which has been performed, numbers 22 to 32 indicate the different steps to perform said method, which consist of maintaining as available an adequate amount of pig skin 22; chopping it up into small pieces 24 having an approximated size of 2 cm per side; frying it 26; draining it off 28; and packaging it 30.

The differences between the homemade method and the industrial method above described could be summarized in that industrial method, the pig skin is cut in small pieces before being fried and it is packed in bags for its display and sale. Even though the finished product is similar in appearance, said product differs in its energy content, total fat, monounsaturated fat, cholesterol, sodium and proteins, as evident in the comparative table below.

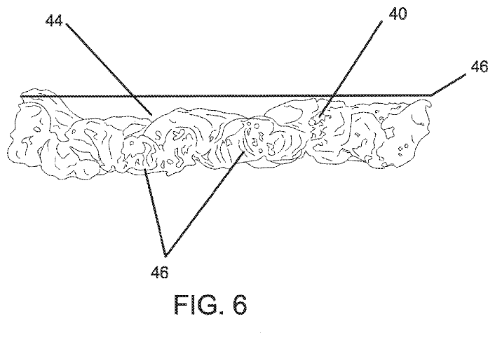

However, regarding the invention method of the present invention as well as the resulting product, which is illustrated at the accompanying FIGS. 3 to 6, both the method and the obtained product show aspects and characteristics that distinguish the methods used until now from the method developed by the inventor and which is claimed, said method including as raw material pig skin 10, but said pig skin should be crushed 12 to a particle size between 2 to 4 mm. The resulting crumbs are disposed in a hopper 14, to be then distributed and poured into moulds having different configuration 16 for receiving the crumbled pig skin, said moulds preheated to a temperature of between about 170 to 200.degree. C.

Once said pig skin crumbs are disposed into the moulds 16, a pressure of about 4 to 8 kg/cm·sup·2 is exerted for a predetermined period of time, which has been found to be suitable between 3 to 6 seconds. Then, the resulting product is discharged. Depending the mould's configuration, said products may be round or square-shaped or any other shape.

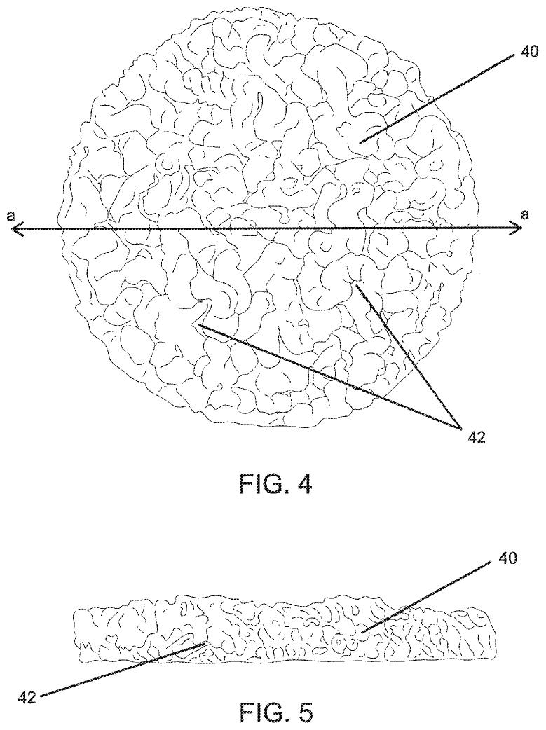

FIGS. 4 to 6 represent, for purposes of illustration, the product 40, which resulted from the method, as a rounded configuration having an approximate diameter from 7 to 10 cm and a thickness of almost 1 cm.

Said product derived from the pork rinds presents a texture of random agglomerate 42, which is shaped by clumping pig skin particles poured into moulds. As a consequence of compressing the pig skin particles, the slices of pork rinds present a sunken face 44 around the crest 46, which may be used to contain a salad or guacamole poured into said slices.

As result of processing the pig skin crumbs, the pork rind slices to be somehow named, form a crunchy product, that is like traditional pork rinds and pleasing to the eye as to the palate, but differ that in fact it could be considered a “light pork rind” which could be consumed by any consumer because it has a lower fat percentage than the traditional pork rind. This is particularly due to the fact that, during its production the step of frying in pork fat is suppressed. This is in addition to the other characteristics presented by said pork rind produced with said method.

The following provides a table containing the summary of the nutritional information of the pork rind produced using a homemade method, an industrial method, as well as the pork rind produced following the teachings of the current invention:

| | Homemade | | Industrial | | Non-fried | |
|---|---|---|---|---|---|---|
| | method | | method | | (invention) | |
| Energy content | 160 | calories | 137 | calories | 110 | calories |
| Total fat | 10.8 | gr | 9 | gr | 3.5 | gr |
| Saturated fat | 4 | gr | 4 | gr | 3.5 | gr |
| Monounsaturated fat | 5.7 | gr | 3.5 | gr | 0.0 | gr |
| Polyunsaturated fat | 1.1 | gr | 1.0 | gr | 0.0 | gr |
| Cholesterol | 29.7 | gr | 20.0 | gr | 18 | gr |
| Sodium | 477 | mg | 430 | mg | 430 | mg |
| Dietary fiber | 0 | gr | 0 | gr | 0.0 | gr |
| Carbohydrates | 0 | gr | 0 | gr | 0.0 | gr |
| Sugar | 0 | gr | 0 | gr | 0.0 | gr |
| Proteins | 15.7 | gr | 14 | gr | 14 | gr |

Approximate shelf life of the three different types of pork rind:

| Homemade method, | Industrial method, | |
|---|---|---|
| fried | fried | Non-fried |
| 2 to 4 weeks | 16 weeks | 18 weeks |

Apparent volume of the three different types of pork rind:

| Homemade method, | Industrial method, | |
|---|---|---|
| fried | fried | Non-fried |
| 100 gr/lt | 46 gr/lt | 23 gr/lt |

Differences between proportional cost of production:

| Homemade method, | Industrial method, | |
|---|---|---|
| fried | fried | Non-fried |
| 100 | 100 | 80 |

From the data previously provided, it is clear that the food product of the invention, which protection is claimed, offers novel characteristics in both its configuration and its nutritional qualities. Even said product may be considered as a pork rind substitute in the current market, as it is obviously a different product which preserves the qualities of a natural origin product and which is additive-free. And as a result of the method used to process the pig skin, it has been possible to industrialize and place in the market an improved, natural and a well-accepted edible product.

Accordingly with the previously described, it is clear that all the objectives have been satisfied, and considering it may be possible that changes can be devised in the method and product obtained, it is intended that said changes be considered as part of the invention which is intended to be protected, if and when it is considered that said changes fall in the scope of the accompanying claims.

1. A method for preparing an edible product of animal origin, comprising the steps of: a) crumbling pig skin to a size of between 2 and 4 mm to form crumbled pig skin; b) metering the crumbled pig skin into previously heated moulds; c) subjecting the crumbled pig skin in the previously heated moulds to pressure for a certain period of time to form moulded pork rinds; and d) retrieving the moulded pork rinds.

2. The method according to claim 1, further comprising placing the moulded pork rinds in bags to be distributed and sold.

3. The method according to claim 1, wherein the crumbled pig skin of step a) is mixed with crumbs of pig skin having a size less than the size of the crumbled pig skin, in a proportion such that the crumbs of pig skin does not exceed 10% of the total crumbled pig skin used, prior to metering into the previously heated moulds.

4. The method according to claim 1, wherein previously heated moulds are heated to a temperature between about 170° C. to about 210° C., and the pressure varies from a value between about 4 to about 8 kg/cm² during a residence time in the moulds that varies from about 3 to about 6 seconds.

5. The method according to claim 1, wherein the moulded pork rinds comprise a substantially rounded configuration and a consistency allowing the moulded pork rinds to maintain the substantially rounded configuration inside the bags.

6. The method according to claim 1, wherein steps b) and c) are performed without adding additional fat to the fat that is already inherent in the crumbled pig skin.

7. The method according to claim 1, wherein the moulded pork rinds have a substantially lower density, fat content and energy content than fried pork rinds obtained by a homemade method.

8. The method according to claim 1 wherein the moulded pork rinds have a fat content of about 3.5 grams per standing serving, an energy content of about 110 calories per standard serving, and apparent volume or density of about 23 gr/It per standard serving, which is about 40 to 50% lower than that the density of a homemade pork rind.

9. The method according to claim 1, wherein the moulded pork rinds have about 3.5 grams of saturated fat, a cholesterol content of about 18 grams, and an apparent volume or density of about 23 gr/It per standard serving.

10. The method according to claim 1, wherein the moulded pork rinds comprise a substantially rounded configuration, deriving from the shape of the previously heated moulds used.

11. The method according to claim 1, wherein the moulded pork rinds comprise a substantially square configuration, deriving from the shape of the previously heated moulds used.

12. The method according to claim 1, wherein the moulded pork rinds comprise a substantially square configuration and a consistency allowing the moulded pork rinds to maintain the substantially square configuration inside the bags.

13. The method according to claim 1, wherein the moulded pork rinds have a texture of random agglomerates and a substantially concave configuration.

14. The method according to claim 1, wherein previously heated moulds are heated to a temperature between about 200° C. to about 210° C.

15. An edible product comprising unfried moulded pork rinds having a texture of random agglomerates, a fat content of about 3.5 grams, and an energy content of about 110 calories per standard serving.

16. The edible product of claim 15, wherein the unfried moulded pork rinds have about 3.5 grams of saturated fat, a cholesterol content of about 18 grams, and apparent volume or density of about 23 gr/It per standard serving, which is about 40% to 50% lower than that of the density of a homemade pork rind.

17. The edible product of claim 15, wherein the unfried moulded pork rinds have a substantially concave configuration.
